(19) United States
(12) Patent Application Publication
(10) Pub. No.: US 2014/0236530 A1
(43) Pub. Date: Aug. 21, 2014

(54) SYSTEMS AND METHODS FOR MEASURING AND REWARDING ACTIVITY LEVELS

(71) Applicant: SQORD Inc., Chapel Hill, NC (US)

(72) Inventors: Coleman Greene, Chapel Hill, NC (US); Jeff Wright, Apex, NC (US); Viswanath Avasarala, Morrisville, NC (US)

(73) Assignee: SQORD Inc., Chapel Hill, NC (US)

(21) Appl. No.: 14/183,514

(22) Filed: Feb. 18, 2014

Related U.S. Application Data
(60) Provisional application No. 61/765,575, filed on Feb. 15, 2013.

(51) Int. Cl. G01P 15/00

(52) U.S. Cl. CPC G01P 15/00
USPC 702/141

(57) ABSTRACT

Systems and methods include a device and an algorithm for measuring adherence to various activity goals (e.g., time-based goals) and collecting ad-hoc game metrics using accelerometers or other sensors. Some embodiments can provide reduced computational, memory, or communications costs over conventional algorithms. In one embodiment, the resulting reduced battery usage can enable a device that is long-lasting, without the need for frequent recharging. This reduction, in turn, can enable the device to be sealed with limited or no external access. Another embodiment can include or interact with social networks and other online data sources to improve activity recognition.

### CROSS-REFERENCE TO RELATED APPLICATIONS

This application claims priority and the benefit under 35 U.S.C. §119(e) of U.S. Provisional Patent Application No. 61/765,575, filed 15 Feb. 2013, of which the entire contents and substance are hereby incorporated by reference as if fully set forth below

### BACKGROUND

Our society as a whole is becoming more sedentary. The pre-teen and teen community, in particular, has seen a significant dip in physical activity in recent years. Current health guidelines, including those from the World Health Organization (WHO) and the U.S. government, focus on activity for children. Current U.S. and WHO guidelines, for example, provide that children ages 5-17 should perform at least sixty minutes of moderate- to vigorous-intensity physical activity daily. Accelerometers previously have been used to measure human physical activity. Conventional activity measurement systems incorporating accelerometers, however, are not geared towards motivating children.

### SUMMARY

Based on extensive testing with children using multiple devices of varying form factors, advantageous attributes have been determined for child-specific activity monitoring systems including, but not limited to:
1) Environment Proof: Kid-friendly devices are ideally robust, and resistant to, for example, water, shock, sand, and dust;
2) Ease of syncing data: Kid-friendly devices ideally enable convenient methods for synching data, both in terms of number of steps required to upload data (e.g., to a website or a PC) and the amount of time required to “sync” data;
3) Low Cost: Kid-friendly devices are ideally low cost; and
4) Data Richness: In addition to providing information and motivation to the user, the data generated can also be useful to, for example and not limitation, school administrators, parents, and health-care providers. Different audiences may be interested in different types of data. Parents or school administrators, for example, may be interested in standard health metrics such as, “is the user performing sixty minutes of activity daily” or “is the user taking 10,000 steps per day.” Kids, on the other hand, may simply be interested in game metrics.

These factors present tradeoffs in device design. For example, making the device environment proof by sealing it prevents connectors like USB ports that can enable recharging and quick data transmission. Using wireless methods to communicate, on the other hand, can increase the amount time required to sync, especially when comprehensive data is to be saved for further analysis, and can increase costs. Adding the ability to function without the need to recharge can require sophisticated energy sources that increase the cost of a device.

Conventional devices do not sufficiently address at least the above requirements. Some embodiments of the system disclosed herein, or the Sqord platform, can use multi-axis accelerometer technology, among other things, to measure the activity of users and can incorporate a social-network enabled game platform to make play and other activity fun for kids.

According to one embodiment of the invention, a system is provided. The system may include a processor, an orientation sensor operatively coupled to the processor, and a memory operatively coupled to the processor and configured for storing data and instructions. The data and instructions, when executed by the at least one processor, may cause the system to perform a method. The method may include receiving sensor data from the orientation sensor, the sensor data sampled at N hertz, wherein N is a predetermined frequency. The method may further include determining, by the processor, and based on the sensor data, a number of steps by a human user per a unit of time. The method may yet further include storing, on the memory, and based on the number of steps, a binary activity level in a sliding t minute window, wherein t is a predetermined amount of time. The method may also include generating, by the processor, a binary string T comprising N consecutive time-slots, each time-slot from the N consecutive time-slots, indicating t minutes of activity. The generating the binary string T may comprise, responsive to determining, in a first instance, that the number of steps in the sliding t minute window exceeds a predetermined threshold, assigning a 1 to a time slot corresponding to the first instance, and responsive to determining, in a first instance, that the number of steps in the sliding t minute window does not exceed the predetermined threshold, assigning a 0 to a time slot corresponding to the second instance. The method may further include outputting, to a processor external to the system, the binary string.

### BRIEF DESCRIPTION OF THE DRAWINGS

FIG. 1 depicts a sample activity histogram 100, in accordance with some embodiments of the present invention.

FIG. 2 depicts the activity histogram of FIG. 1 approximated by a triangle distribution 200, in accordance with some embodiments of the present invention.

FIG. 3 depicts a fictitious set of basis functions 300 for activity histograms, in accordance with some embodiments of the present invention.

FIG. 4 depicts lazy learning architecture 400 for inference of body location, in accordance with some embodiments of the present invention.

FIG. 5 depicts model-based learning architecture 500 for inference of body location, in accordance with some embodiments of the present invention.

FIG. 6 depicts a simulated time series 600, in accordance with some embodiments of the present invention.

FIG. 7 depicts an accelerometer device 700 in communication with a social network 750, in accordance with some embodiments of the present invention.

FIG. 8 depicts an illustrative block diagram of computing device system architecture 800, in accordance with some embodiments of the present invention.

### DETAILED DESCRIPTION

### 1. Introduction

Embodiments of the present invention include systems and methods for use with a device and algorithm for measuring adherence to various activity goals (e.g., time-based goals) using accelerometers, and/or other sensors, while enabling the collection of multiple ad-hoc game metrics. Some embodiments of the system can provide this functionality with vastly reduced computational, memory, and communications costs when compared to conventional algorithms. The algorithm can enable some embodiments to reduce memory requirements on the chip and significantly reduce the energy and time required to send data wirelessly from the device. In addition, the reduced battery usage can enable an example device that is long-lasting, without the need for frequent recharging. This reduction, in turn, can enable the device to be sealed with limited or no external access. In this manner, the device can be substantially water resistant.

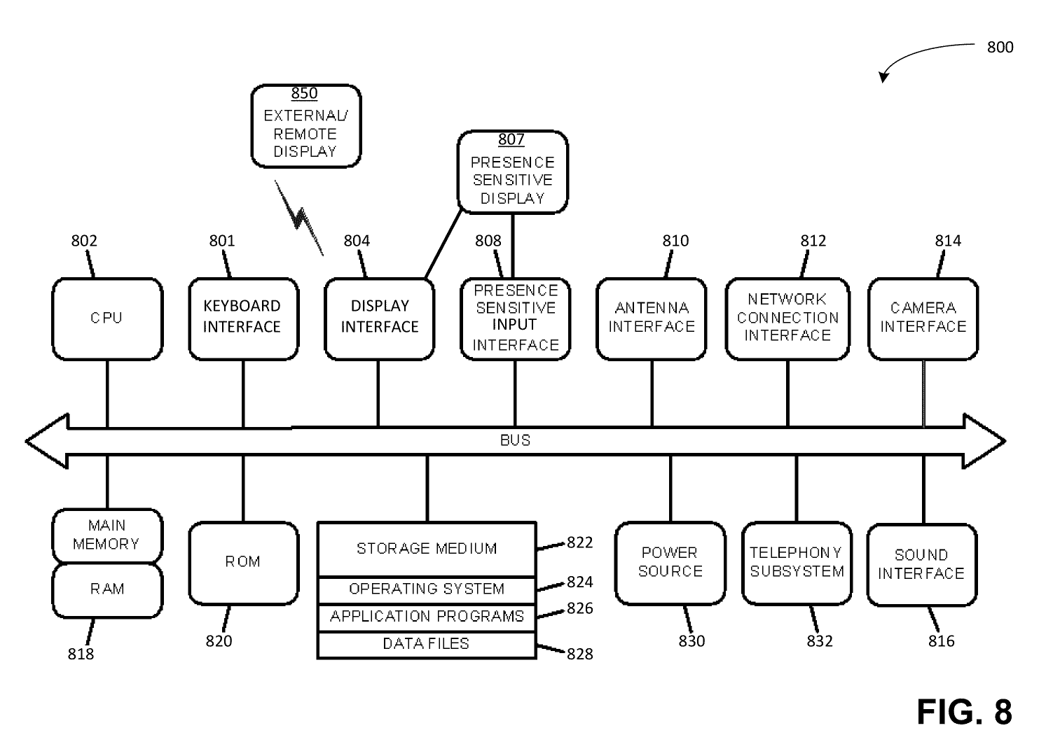

An example core algorithm for use with some embodiments of the present invention is discussed below. One or more parts of the algorithm may be performed on a computing device, such as one having the example architecture illustrated in FIG. 8. Extensions and variations to the algorithm can enable certain embodiments to dynamically adapt activity thresholds and to allow more sophisticated data analytics. Some of these additional features are also discussed below. For ease of reference, the term “health metric,” as used herein, refers to the U.S./WHO guideline of “60 minutes or more of moderate to vigorous daily physical activity.” However, this metric is provided only for example, and one of skill in the art will recognize that the algorithms presented herein are not so limited.

### 2. Core Algorithm

In an example embodiment, the algorithm can include:
1) An accelerometer reading is sampled at N Hz.
2) A step counting algorithm for accelerometer data is used to integrate the accelerometer data and calculate the number of steps per unit of time.
3) A record of the number of steps in a sliding t minute window can be stored on the device.
   a. If the number of steps is greater than a threshold X, then the sliding window is recorded as being active (i.e., assigned a value of 1); and
   b. If not, the window defaults to inactive (i.e., assigned a value of 0).
4) A binary string T composed of N consecutive time-slots, each indicating t minutes of activity, is recorded and serves as a summary of the total active time of the user.

The threshold X can be pre-determined, for example, on the left boundary (i.e., the minimum) for medium intensity activity. In other words, in an example embodiment, a user needs to record at least X number of steps in at minute window to have successfully accomplished medium, or higher, intensity activity.

### 3. Dynamic Threshold Learning

Embodiments of the present invention can encourage activity for kids. It is important that kids who do not meet health metrics are motivated to increase their activity level. One caveat with the example core algorithm described above, however, is that it can have a fairly rigid threshold for counting activity, as explained below:

For example, in one scenario, an inactive kid is fairly excited about using Sqord and makes a concerted effort to be active. Much of the time, however, due to his low stamina, among other things, he fails to meet the threshold for medium activity and, thus, records mainly zeros in the binary string T. As a result, though he has increased his activity level, the resulting negative feedback serves only to discourage the child (e.g., despite his efforts, perhaps only one of his attempts to be “active” has been recorded/reported).

Another caveat with the example core algorithm, above, is a possible inability to answer statistical questions aside from those based on the set threshold. An administrator may not be able to discern based on the data, for example:
1. Of all the children who are not meeting the 60 minute guideline, what percentage of children are getting at least low-medium activity for at least 30 minutes?
2. For a particular child, who is meeting the threshold of 60 minutes, what fraction of his/her activity is of high or very high intensity?

These scenarios can be attributed to the inability of core algorithm to differentiate between the spectra of activities. In other words, the algorithm may be unable to differentiate between no- and low-activity intensity (i.e., all are recorded as 0s) and/or between medium and very high intensity (i.e., all are recorded as 1s). This problem can be solved, however, using traditional high-cost accelerometers, which are commercially available. This is possible because these units can record the number of steps vs. time with very high granularity. The added granularity of data, however, can also come with a significant rise in both actual cost (e.g., the cost of the sensing device) and communication costs (e.g., the cost of uploading additional data to the server).

To this end, the core algorithm can be modified to learn dynamic thresholds without losing the ability to strictly measure adherence to the health-metric. To explain the dynamic threshold learning algorithm, the notion of activity-time histograms, histogram basis functions, and histogram distance functions is introduced herein.

### 3.1 Activity Histograms

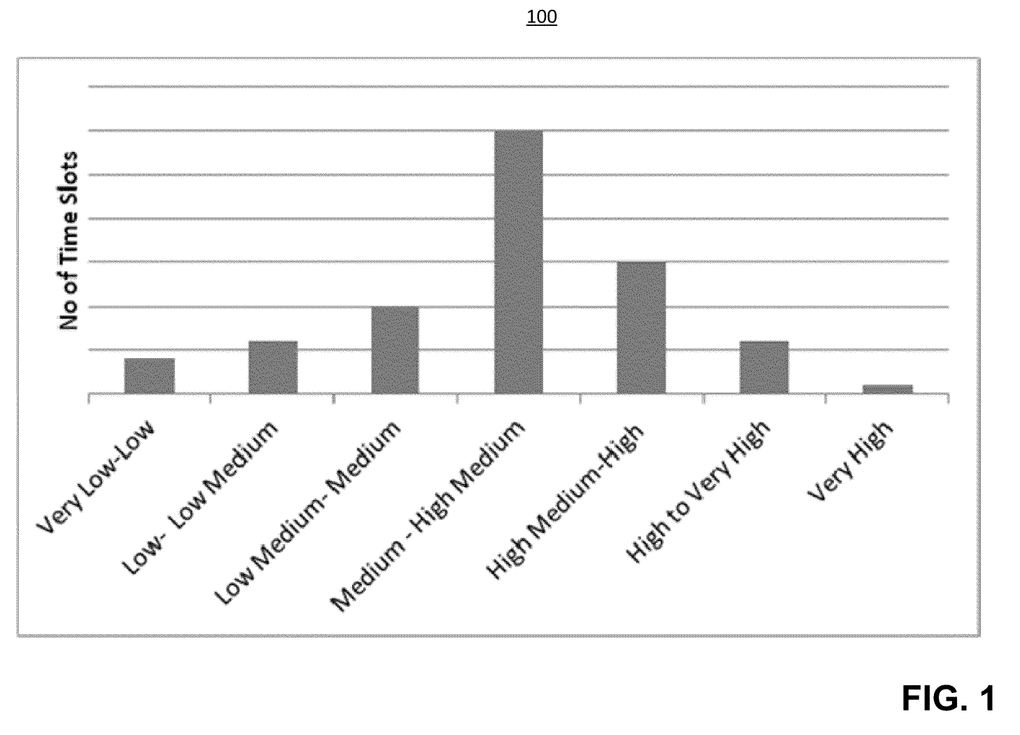

Consider a time period of length M with K number of time slots of t length. That is, M=tK. If M is 24 hours, for example, then K=240 when t=6 minutes. After discretizing the activity levels into an ordered set, the histogram of activity over the time period can be easily calculated. A sample histogram is shown in FIG. 1.

### 3.2 Histogram Compression

The histograms can be high-dimensional vectors having as many dimensions as the number of bins. A popular method to reduce the dimensionality of a histogram is to use standard distribution functions to represent them. For a given histogram, for example, its distance to a chosen family of distributions can be calculated and the histogram can be represented with the closest distribution from the given family. This can enable a low-dimensional representation of a high-dimensional histogram vector. A two-dimensional triangle, square, or truncated Gaussian distribution, for example, can be used to represent histograms. Because these distributions have two parameters, the algorithm can reduce a multi-dimensional histogram to a two-dimensional vector.

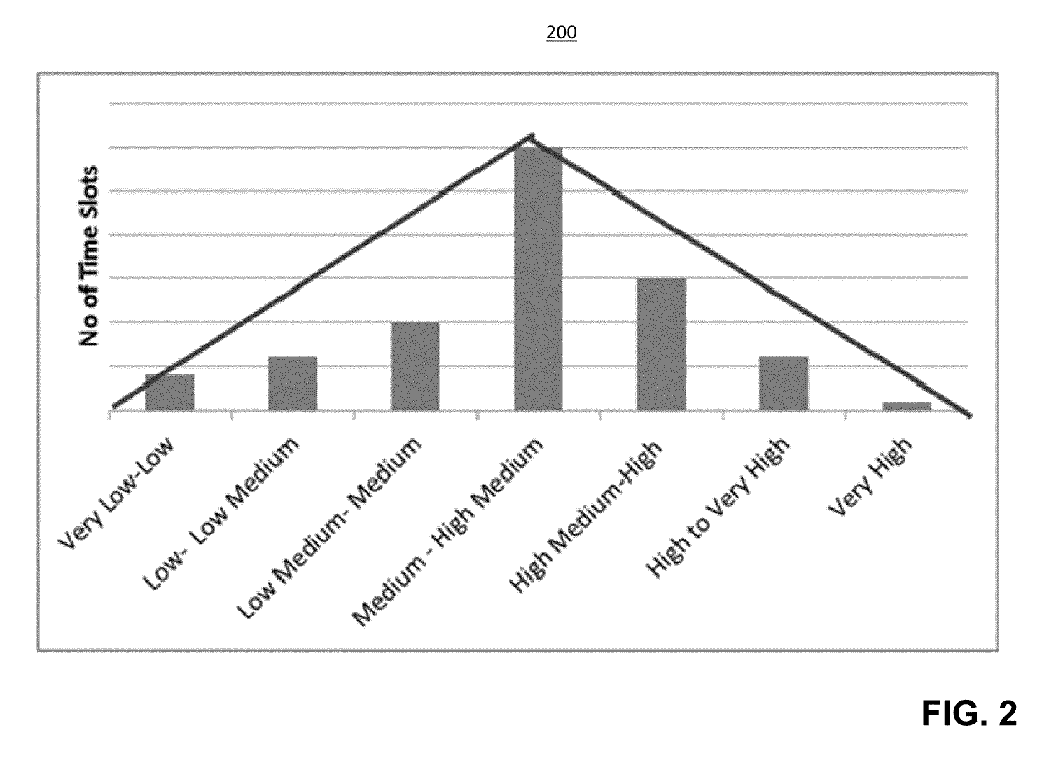

For the activity histogram, the majority of time-slots can be expected to fall in the zero and very-low activity bins because they capture sedentary time including sleep and other idle actions (e.g., sitting in class). Ignoring these bins, therefore, the remaining histogram can be captured by a standard distribution by using a minimum distance metric. In other words, for a given histogram, the parameters of a distribution can be calculated with a pre-decided shape that has the minimum distance to the actual histogram. The histogram in FIG. 1, for example, can be captured favorable with a triangle distribution as shown in FIG. 2. To calculate the distance from a histogram to a given distribution, the characteristic statistics of the histogram can be calculated, for example, and the histogram can be represented using a distribution function with the same, or similar, characteristic parameters.

### 3.3 Characteristic Distributions

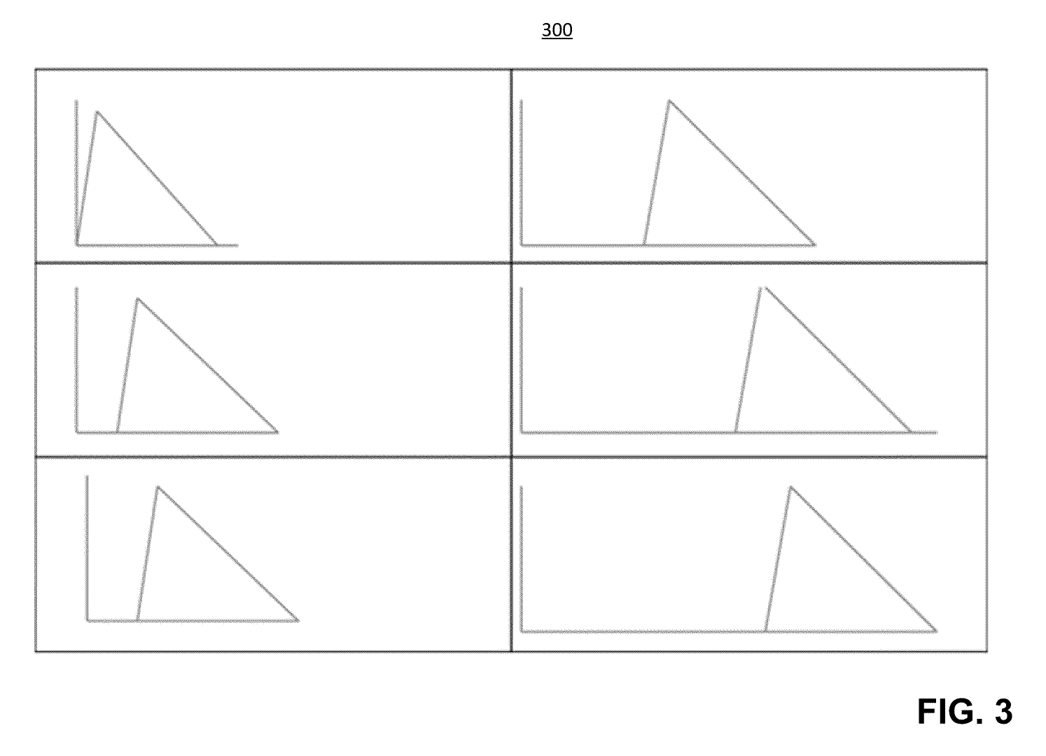

Rather than allow an entire family of distributions to represent activity histograms, however, the number of choices can be further restricted by pre-deciding a subset of the distributions. FIG. 3, for example, depicts a fictitious set of distributions that can be regarded as a basis function for activity histograms. The distance of activity histogram to a basis function can be calculated using standard histogram divergence methods such as, for example and not limitation, the Kullback-Leibler distance or the Chi-square distance to determine the best distribution.

In addition, the characteristic histograms can be divided into two sets: one set which meets the health metric and the complementary set that fails to do so. These can be referred to as the RIGHT SET and LEFT SET, respectively. In this configuration, all histograms in the RIGHT SET have at-least b number of bins with activity greater than moderate-level, where b is the smallest number such that b*t≧60 minutes (i.e., users who meet the minimum activity level).

### 3.4 Dynamic Threshold Algorithm

Based on the above, the example core algorithm can be modified as follows:
1) The activity histogram is calculated over the time-series stored in the device.
2) The number of bins y with activity that meet the threshold ‘X’ (i.e., medium activity or above) are calculated.
3) The characteristic distribution of the activity histogram is calculated using the appropriate arithmetic measure (e.g., a Kullback-Leibler distance). If yₜ≧60 minutes, only the RIGHT SET is used. If not, only the LEFT SET is used.
4) Depending on the characteristic histogram of the activity histogram, a threshold is set to threshold the activity into 0s and 1s to determine the T string corresponding to the user message.
5) In some embodiments, in addition to the current information, an additional variable ‘C’ can be appended to the data uploaded by the device to indicate which characteristic histogram was used. For eight characteristic histograms, for example, a three-bit variable can be used to represent ‘C’.

The characteristic threshold can be any simple statistic of the activity histogram such as, for example, it's mean, median, maximum, or minimum. The threshold's upper limit can be restricted to ‘X’. The mapping of the histogram to “characteristic distribution” is optional, but can be useful to save the memory required to communicate the distribution parameters. Instead, the closest distribution from a family of distributions can be used to communicate the parameters of the distribution along with the remaining data.

If a family of truncated normal distributions was used to represent the histograms, for example, it can be desirable to also communicate the two floats associated with the distribution μ and a along all other data.

$$f ( x ; μ , σ , a , b ) = \frac{\frac{1}{σ} φ ( \frac{\text{?} - μ}{\text{?}} )}{\text{?} ( \frac{\text{?} - \text{?}}{\text{?}} ) - \text{?} ( \frac{a - μ}{\text{?}} )}$$

$$\text{?} \text{indicates text missing or illegible when filed}$$

In light of this, the advantages of using the three bits required to communicate the distribution parameters when using an eight-member characteristic histogram family become apparent.

### 4. Dynamic Thresholds Based on Time Series Change Detection

In some embodiments, an additional algorithm that provides a richer data set can be used, without generating a significantly larger amount of data, as shown below:
1) A set of thresholds (β₁ . . . βₙ) can be determined and tagged with a corresponding activity level (e.g., low, medium, or high).
2) Detection of change in activity levels can be provided using, for example, optimization time series, sequential time series, or a moving average filter algorithm.
3) The change points and the change-thresholds can be saved and uploaded to the server and can be decoded on the server to generate a time-series representation of the data. For example, a binary string T can be constructed at N consecutive time-slots, each time slots indicating ‘t’ minutes of recorded activity. Where the i-th element of T equals 1 if i is a change point or 0 otherwise.

In some embodiments, in step 1, the set of thresholds B=(β₁ . . . βₙ) can be empirically determined. In other words, in some embodiments, human subjects can engage in a set of activities known to generate a certain level of activity (e.g., high intensity). Using this data, the average per-unit activity level observed during these experiments can be used to determine the threshold corresponding to that activity level.

In other embodiments, a different of set of thresholds B, or a different mapping of the thresholds to activity levels, can be used depending on where the device is worn during the activity. In some embodiments, the locations (e.g., body position) of the device can be manually provided by the user (e.g., on a website) to determine the activity level corresponding to a certain segment. In other embodiments, the locations of the device can be automatically determined by an online or offline data-mining algorithm that uses features of the time series.

In some embodiments, for the raw time series signals, the features of the time series including, for example, the mean, median, kurtosis, variance, and various statistical moments, can be calculated. In some embodiments, a lazy learning algorithm, for example, Case-Base reasoning can be used to identify the body position of the sensor. In other embodiments, model-based learning algorithms, for example, back-propagation neural networks or decision trees can be used to identify the body position of the sensor.

For each body part location, a training set can be obtained by performing activities wearing the device in various locations, retrieving the time series data, and calculating features of the time series data. Features of the time series data in the time domain can be sliding window-based statistical properties, including, but not limited to:

Median;

Maximum;

Minimum;

Range;

Standard deviation;

Percentiles;

Autocorrelation;

Skewness;

Kurtosis;

Higher Order Moments; and

Entropy.

The time series can be projected into frequency domain (e.g., using a Discrete Fourier Transform) or a tiling of the time-frequency plane (e.g., using a Discrete Wavelet Transform). In some embodiments, the lowest or highest energy coefficients can be used as the features of the underlying time series.

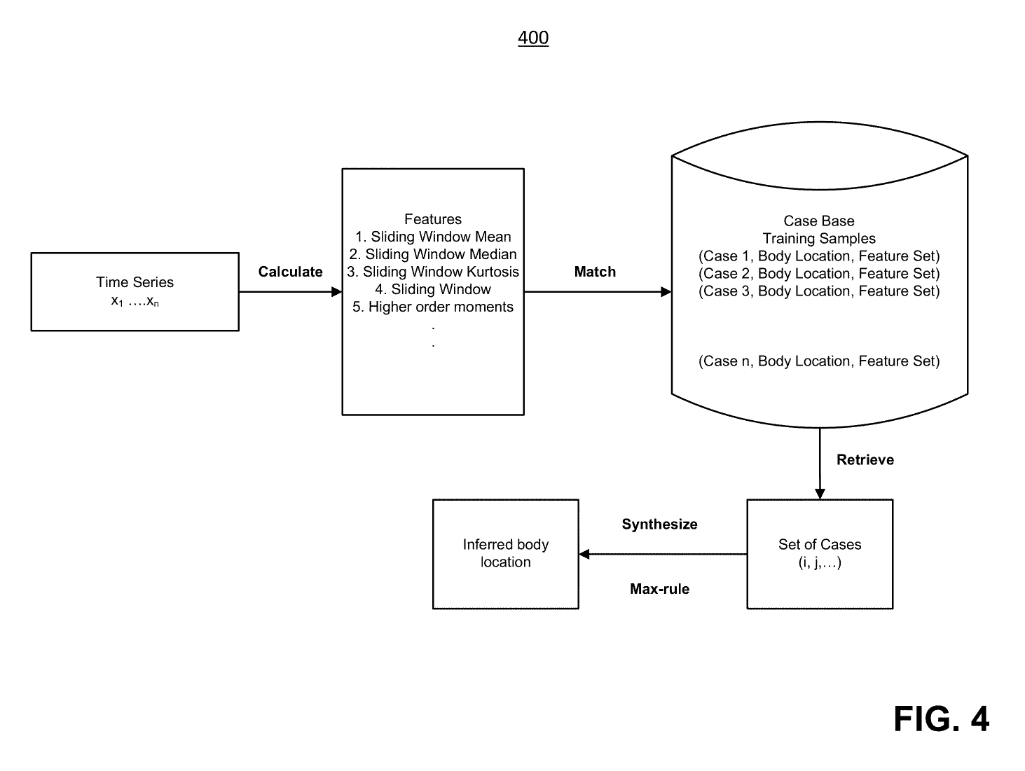

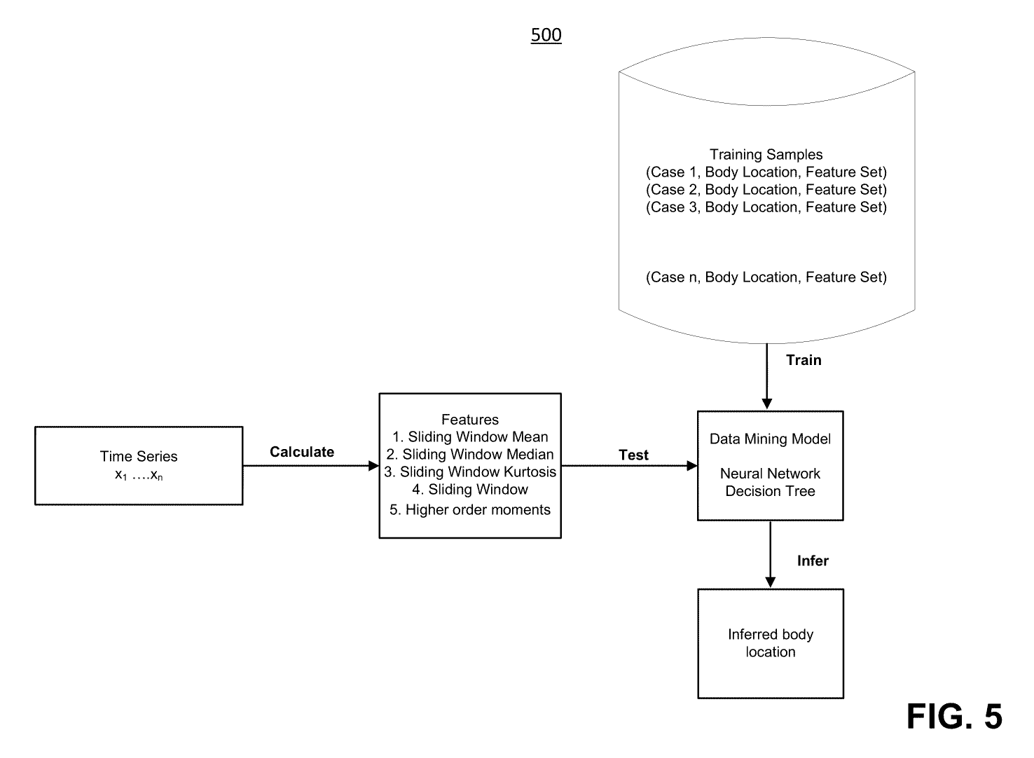

A model can then be developed to infer the body location of the sensor using the labeled samples in the training set. As shown in FIG. 4, using lazy learning, for example, the model can be the set of labeled training samples. As shown in FIG. 5, using model-based learning, on the other hand, the training data can be used to generate a model that the test data can be run against. Standard machine learning models can be used for inferring locations like, for example, back-propagation neural networks or decision trees.

In an example embodiment, the algorithm can include:
1) Determine the change point of the time series using one or more of the algorithms described in section 4.1 using set B₀={B₁, B₂} to determine if the user is active or taking part in activity.
2) For each activity period of the time series as detected by algorithms described in Section 4.1, calculate the features of the time series.
3) Infer the body location of the time series using lazy learning or model based learning, as described above.

### 4.1.1 Detecting Multiple Activity Levels

Comparing particular time series points to a threshold to determine if it belongs to a certain activity level can be unreliable. A random spike (or fall) in sensor readings can occur due to, for example, sensor inaccuracies or random movements that may not be related to a systematic activity pattern. For a point to be designated as the beginning of a new activity pattern, the pattern of time series data before and after the point can be different. In some embodiments, this type of behavior can be detected using an algorithm such as moving average filters. For example:

Let x₀ . . . xₙ be the time series of data that is collected on an accelerometer, where n is the latest data point. Let xₘₑₐₙ be the moving average with block size m, such that:

$${x}_{mean} := \frac{1}{m} ( {x}_{n - m} + … + {x}_{m} )$$

Let (β₁ . . . βₙ) be the set of pre-determined activity thresholds. The following is an example moving-average based algorithm to set dynamic thresholds:

xⁿₘₑₐₙ<β₁=>yₙ=0

xⁿₘₑₐₙ>β₁=>yₙ=1

yₙ−yₙ₋₁!=0=>n is a change point. For each change-point, the change threshold can be defined:

tᵢ=0 if (xⁱₘₑₐₙ<β₁)

tⱼ=1 if (xⁱₘₑₐₙ>βᵢ & xⁱₘₑₐₙ<βᵢ₊₁)

tⱼ=n if (xⁱₘₑₐₙ>βₙ).

A compression algorithm where only the change points and the change-thresholds are saved and uploaded to the server can then be decoded on the server to generate a time-series representation of the data.

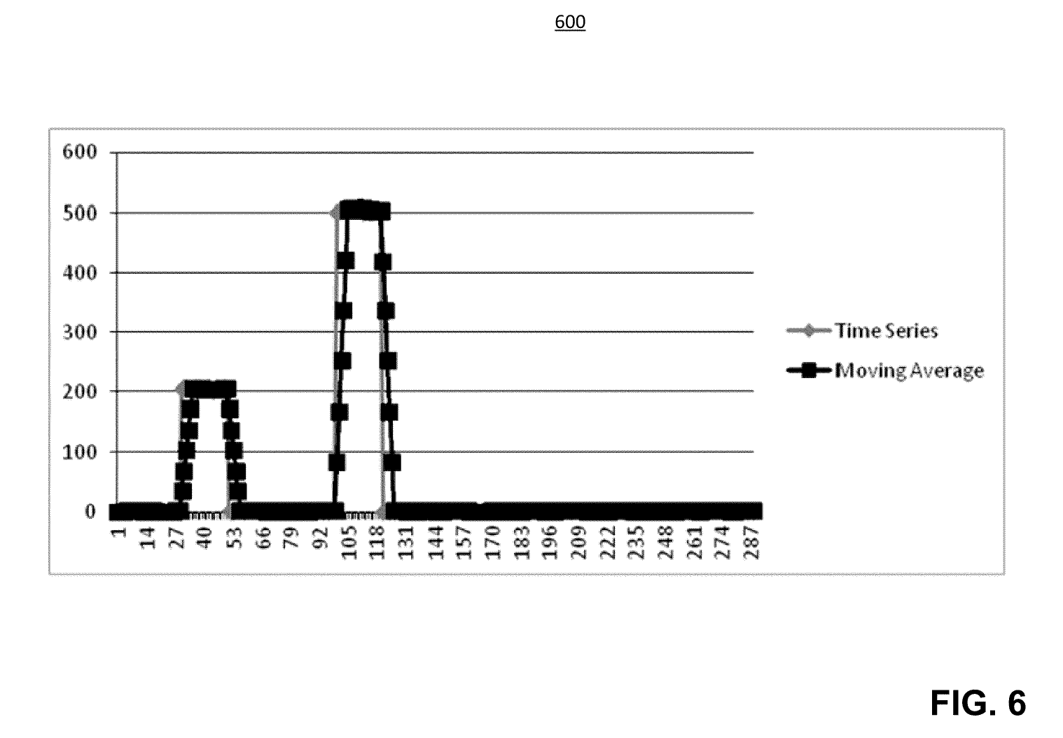

In another example embodiment, instead of the change points, a binary string T composed at N consecutive time-slots each indicating ‘t’ minutes of activity can be recorded, where the i-th element of T equals 1 if i is a change point, or 0 otherwise. For example, FIG. 6, depicts a simulated time series of 24 hour time period with 5 minute intervals. A four length set (β₁,β₂,β₃,β₄) with β₁=200, β₂=500, β₃=800, β₄=600 was used.

### 4.1.2 Optimization-Based Change Point Detection

In some embodiments, a sequential change detection algorithm can be used for activity threshold/detection. For example, Let (xₖ)_{k=1:m} be a sequence of data collected by an accelerometer with a conditional density p_{θ}(xₖ/xₖ₋₁, . . . x₁) where θ is a conditional density parameter that is dependent on the intensity of activity. Let θ_{0 . . . m} be the conditional density parameters that are related to m different levels of activity. It can be desirable, therefore, to detect the m change points, their locations and the corresponding change locations.

Let C={c₁ . . . cₘ} be the ordered set of change points of the m change points such that i<j=>cᵢ<cⱼ. In this configuration, the m change points split the data into m+1 segments where the k-th segment corresponds to (cₖ₋₁+1 to cₖ); with c₀=0 and cₘ+1=n. Also, cᵢ≧1 and cᵢ≦n−1.

The mean of the i-th segment can be defined as:

$${μ}_{i} = \frac{1}{{C}_{i} - {C}_{i - 1} + 1} {\sum }_{k = {C}_{i - 1} + 1}^{{C}_{i}} {x}_{k}$$

$${σ}_{i}^{2} = \frac{1}{{C}_{i} - {C}_{i - 1}} {\sum }_{k = {C}_{i - 1} + 1}^{{C}_{i}} {( {x}_{k} - {μ}_{i} )}^{2}$$

The kernel mean can be defined as:
μ_{\dot{i}} the β closest to μᵢ from the set B.
μᵢ⁺ as the smallest β greater than μ_{\dot{i}}
μᵢ⁻ as the largest β greater than μ_{\dot{i}}

The m-change detection points can then be solved by Equation 1:

$${\sum }_{i = 1}^{m + 1} g ( i ) + γ f ( m ) , \qquad EQ 1$$

where g is a cost function that evaluates the cost associated with a segment. g could be, for example, the log-likelihood of a segment. Assuming the data is Gaussian, therefore, with a different mean and variance for each segment, gives:

$$g ( i ) = log \sqrt{2 π} + log {σ}_{i} + {\sum }_{j = {C}_{i - 1} + 1}^{{C}_{i}} \frac{{( {x}_{j} - {μ}_{i} )}^{2}}{{σ}_{i}}$$

If variance is assumed to be equal for all segments, then:

$$g ( i ) = {\sum }_{j = {C}_{i - 1} + 1}^{{C}_{i}} \frac{{( {x}_{j} - {μ}_{i} )}^{2}}{{σ}_{i}}$$

In this configuration, any function that monotonically increases with m, such as f(m)=2m or m*(log(n)), for example, can be used for f(m). To solve for m change points, therefore, m=1 can be chosen and Equation 1 solved to find the best location for the first change point. Next, the time series can be split into a right and left time series at c₁. The above loop can then be iterated for both right and left series until a series is no longer split. This method is simple, but is locally greedy. In other words, once you select a change point, no changes are made to it. To avoid this, the optimization problem can also be solved using a local stochastic search or evolutionary algorithms similar to genetic algorithms.

For an example local stochastic search, for each point i from 1 to n, Equation 1 is evaluated with c₁=i as if it were the only change point and call it the score(i). In an example embodiment, the local stochastic algorithm can include:
1) Start with an empty list of change points.
2) At each step, with a probability of a, choose a random, unselected point and add it to the list of change points.
3) With a probability of (1−a), choose either the best available or the second best available change point as defined by their scores:
   a) If the best available change point has been selected for inclusion in the solution, later than the second available change point, then it is selected.
   b) Otherwise, it is selected with a probability b and the second best available change point with probability (1−b).
4) Optionally, once a point is added to the list of change points, it can either be considered as active or inactive depending on whether the score in Equation 1 improves for the current set of change points after its addition.

Steps 2 and 4 can be repeated for the maximum number of steps (“maxsteps”) and the whole process can be repeated for the maximum number of tries (“maxtries”). An improved solution can then be chosen after maxtries number of iterations as the final set of change points. In addition, linear methods can be used to solve the optimization problem.

### 4.1.3 Sequential Algorithm Change Point Detection

In addition, sequential change detection methods such as, for example and not limitation, Stewart's control chart, Geometric average likelihood, forgetting average likelihood, CumSUM, Generalized Likelihood Ratio tests, or Bayesian approaches can be used for detecting multiple change points and corresponding activity levels.

In an example embodiment, let x₁, . . . , xₙ be the time series of data and f₀(xₖ) be the distribution of time series data, assuming zero activity is taking place. f₁(xₖ) is the distribution of time series data assuming activity. For example, fₒ(xₙ) can be truncated normal with mean and variance determined by using data collected from the device when no activity is being performed. f₁(xₙ), on the other hand, can be the truncated normal with mean and variance determined by using data collected from the device when activity is being performed.

Sequential algorithms define the function g as:

gⱼ=0; gₙ=max(0,gₙ₋₁+log(f₁(xₙ/fₒ(xₙ)),

where j is the latest change point detected (1 if 0 change point has been detected yet). If (gₙ>b), then n is a change point, where b is a predetermined threshold.

For GLM, three paramteters can be used: a constant σ for the standard deviation of the distribution, a threshold to select Δ to check for change points, and the forgetting factor α. Two hypotheses are considered, the left hypothesis and right hypothesis.

The left hyphothesis can be calculated as follows:

$$\tilde{{g}_{k , -}} = ( 1 - α ) \tilde{{g}_{k , -}} + α ( {x}_{k} - {μ}_{ι}^{\cdot } ) , and$$

$$\tilde{{g}_{k , -}} = \frac{{σ}^{2}}{{μ}_{ι}^{\cdot } - {μ}_{i}^{-}} {g}_{k , -} - \frac{{μ}_{ι}^{\cdot } - {μ}_{i}^{-}}{2}$$

The right hypothesis can be calculated as follows:

$$\tilde{{g}_{k , +}} = ( 1 - α ) \tilde{{g}_{k - 1 , +}} + α ( {x}_{k} - {μ}_{ι}^{\cdot } ) , and$$

$$\tilde{{g}_{k}} = \frac{{σ}^{2}}{{μ}_{ι}^{+} {μ}_{ι}^{\cdot }} {g}_{k} - \frac{{μ}_{i}^{+} - {μ}_{ι}^{\cdot }}{2} .$$

After each changed point is detected at j, gⱼ can be reinitialized to zero. The k-th point can be declared a change point if either g_{\tilde{k}\tilde{,}\tilde{+}} or g_{\tilde{k}\tilde{,}\tilde{-}} are greater than a predetermined threshold.

Similarly, a simple weighted sum could be used and compared to a threshold for change point detection:

gₖ=Σᵢ₌₀^{k}∝ᵢ(xₖ−μ_{\dot{i}}).

After each change point is detected at j, gⱼ can be reinitialized to zero. gₖ can be a change point if |gₖ| is greater than a pre-determined threshold.

In an example embodiment, using the CumSUM algorithm, define:

$${s}_{k} = log \frac{{p}_{{θ}_{1}} ( {x}_{k} )}{{p}_{{θ}_{0}} ( {x}_{k} )} , and$$

$${S}_{k} = {\sum }_{j = {C}_{i}}^{k} {s}_{k} ,$$

where Cᵢ is the largest change-point smaller than k, and

gₖ=min_{c}_{ᵢ}^{<j<k}Sⱼ.

k is a change point if Sₖ−gₖ≧h, where h is a pre-defined threshold.

Assuming data is distributed normally with constant variance, the two sided CumSUM test can be used to detect shift in activity levels as follows

$${S}_{k , +} = \frac{{μ}_{i}^{+} - {μ}_{ι}^{\cdot }}{{σ}^{2}} {\sum }_{j = {C}_{i}}^{k} ( {x}_{j} - \frac{( {μ}_{i}^{+} + {μ}_{ι}^{\cdot } )}{2} ) and$$

$${S}_{k , -} = \frac{{μ}_{1} {μ}_{1}^{-}}{{σ}^{2}} {{\sum }_{j = {C}_{i}}}^{k} ( {x}_{j} - \frac{( {μ}_{i}^{-} + {μ}_{ι}^{\cdot } )}{2} ) , \\ {g}_{k , -} = {min}_{{c}_{i} < j < k} {S}_{j , -} and$$

$${g}_{k , +} = {min}_{{C}_{i} < j < k} {S}_{j , +} .$$

k is change point if Sₖ₊−gₖ₊≧h, Sₖ₋−g_{k,-}≧h.

### 4.1.4 Approximate Number of Steps During Each Time Slot

An example embodiment can also calculate the expected activity accumulated by a user given the thresholds (β₁ . . . βₙ), change points (n₁, . . . , nₖ), the change thresholds (t₁, . . . , tₖ). The expected number of activity points accumulated by a user can equal

$${\sum }_{r = 1}^{r = k} {β}_{{t}_{r}} * ( {n}_{r} - {n}_{r - 1} ) ,$$

where nₒ=0; If the total number of steps taken in the total time S is known, the number of steps in an interval can be approximated as:

S*βₜ_{ⱼ}*(nⱼ−nⱼ₋₁)/Σᵣ₌₁^{r=k}βₜ_{ᵣ}*(nᵣ−nᵣ₋₁).

### 4.1 Simple Footprint

The example algorithm has a very simple footprint on the hardware since it uses simple arithmetic calculations over variables that are calculated in standard accelerometer hardware.

### 4.1 Data Fidelity

For a given memory size, the algorithm has improved information content. For example, server-side analytics can be used to answer questions of the following nature:

Q 4.1.1) “Is a particular child meeting the health guideline of meeting 60 minutes of moderate to high activity?”

A) The answer is yes, if the characteristic distribution belongs to the RIGHT SET and not otherwise.

Q 4.1.2) “What is the length of time that a particular kid is being vigorously active?”

A) Let h be the number of bins that fall above the high activity level in the kid's characteristic histogram. The length of activity is ht. This is an expected value only since an approximation is involved in representing the kid's activity histogram using the characteristic histogram. However, the approximation has zero bias (the expected value of the answer equals the true value of the metric).

Q. 4.1.3) “What is the number of Low-Moderate intense activity that a particular kid is recording?”

A) (Similar to Q 4.1.2)

Q. 4.1.4) What is the average time that sedentary kids (kids that do not meet the health metric) have at-least low-moderate activity?

A) Σᵢ^{k}cᵢhᵢ where cᵢ is the number of times that i-th LEFT SET has been recorded as the characteristic histogram and hᵢ is the number of bins that i-th LEFT SET to the right of low-moderate activity level. As in Q 4.1.4, this answer is also approximate. However, since this is a population statistic, it has an additional advantageous property. The answer converges strongly to the true value because of the law of large numbers as the number of children in the system increase.

### 4.2 Positive Reinforcement

The threshold can be dynamically determined and depend on the activity patterns of a given user. For a sedentary user, the device can still record below moderate activity as 1 s, without giving upstream credit for meeting the health guidelines.

On the server side, since the characteristic distribution used to measure activity can be known, the ‘1’s from a highly active user and ‘1’ s from a sedentary user can be handled differently. Moreover, a sedentary user can be set motivational targets or given rewards when his threshold is upgraded based on improved activity.

### 4.3 Low Communication and Memory Requirements

Since some embodiments of the algorithm can represent the activity using a binary signal and the characteristic distribution using a few bits, the data collected on the puck is reduced that needs to be transmitted to the server. Two resulting advantages include:

Greatly reducing amount of time required to upload the data; and

Greatly reducing the energy costs of communication.

The low cost of communication provides the freedom of making the battery stand-alone without recharging circuitry. Thus, in some embodiments, the device can be sealed completely from external environment, making it water resistant and robust to rough usage. Moreover, the reduced time of communication allows the use of less sophisticated communication protocols, reducing the comparative expense.

### 4.1.3 Generating Aggregate Time-Series Values

Physical activity level can be calculated, for a non-pregnant, non-lactating adult, as the person's total energy expenditure in a 24-hour period, divided by his or her basal metabolic rate SQORD 1 (BMR), i.e., PAL=total energy/basal metabolic rate. The PAL values for certain physical activities are shown in Table 1, below.

TABLE 1
PAL values for different types of activities

| | PAL |
|---|---|
| Light Activities | |
| Sleep | 1.0 |
| Awake, lying still | 1.2 |
| Sitting - at rest | 1.4 |
| Sitting - and reading | 1.7 |
| Moderate Activities | |
| Vacuuming, sweeping, or cleaning house | 4.0 |
| Walking fast | 4.6 |
| Dancing (moderate speed) | 5.0 |
| Exercise (moderate) | 5.5 |
| Lab work | 6.0 |
| Heavy Activities | |
| Rowing | 12.7 |
| Dancing (fast) | 15.0 |
| Playing Ping-Pong (competitively) | 17.5 |
| Exercise (heavy) | 30.0 |
| Fencing | 37.0 |

An example Sqord device can use a 3-axis accelerometer, which can be sampled at a given frequency to produce a 3-dimensional (3D) vector of real numbers related to the acceleration experienced by the sensor. Traditional activity measuring devices use algorithms based on this 3D vector to measure the number of steps or intensity of a particular activity performed by a user. However, depending on the type and intensity of activity, the accuracy of Energy Expenditure that is predicted by an accelerometer can vary.

In an example embodiment of the present invention, a user can be permitted to label a given time period of activity and adjust the activity reported using PAL values. The adjustment factor can be determined as follows: Choose a certain activity (for example, “walking fast”) as the canonical activity. For any given activity “x”, let Aₓ and Ac be the amount of activity reported by the accelerometer for activity x and the canonical activity respectively in a chosen unit of time. The correction factor associated with x is, (A_{c}*PALₓ)/(Aₓ*PAL_{c}). So, when the user reports the type of activity as x, then the activity points/step count can bemultiplied by the above correction factor. Certain embodiments can use the activity recognition algorithms described in this document to determine x and automatically apply correction factors.

### 5. Activity Recognition by Fusing Accelerometer Data and Social Network Features

Activity recognition from accelerometer data is a well-known machine learning problem. However, accurate recognition of activity can require very high frequency data. However, many commercial devices, including some SQORD devices, can supply very low frequency data to the server. Thus, currently available techniques are unsuitable in such scenarios. Some embodiments of the present innovation can include using a combination of both accelerometer data and features from mining one or more social networks of the user.

For the accelerometer, the time series for each segment detected using the algorithms described in the previous section can be features, which include:

Duration;

Median;

Maximum;

Minimum;

Range;

Standard deviation;

Percentiles;

Autocorrelation;

Skewness;

Kurtosis;

Higher Order Moments; and

Entropy.

Some embodiments of the present invention can also use features of historical data of the user. These features can measure the historic frequency of a particular activity for the user and the frequency of activity during the concerned time period.

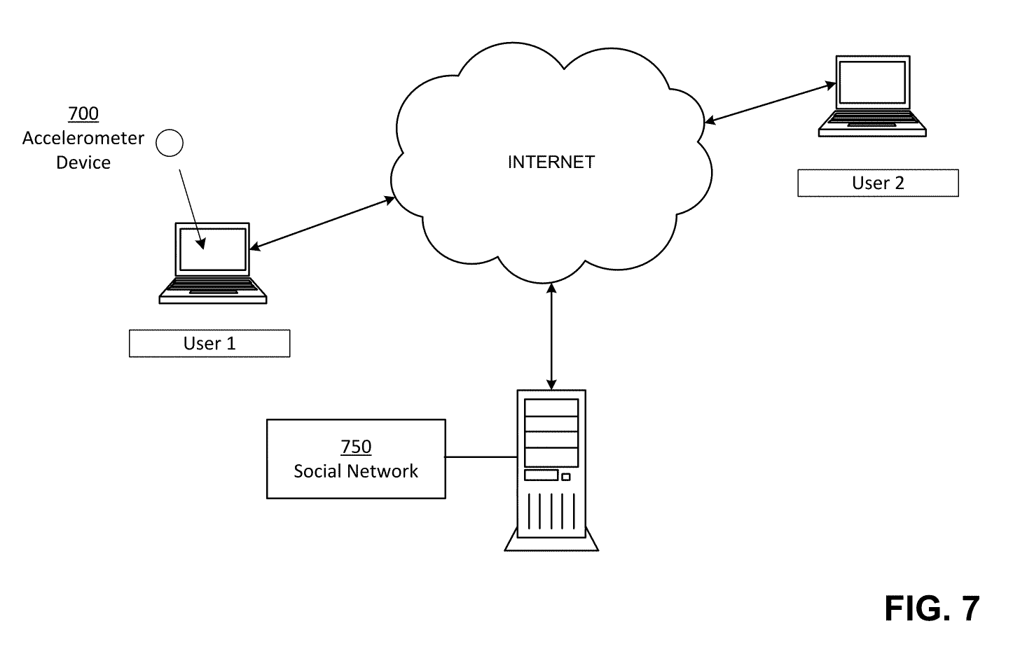

In addition, some embodiments of the present invention can mine the social network of the user to identify useful features. FIG. 7 depicts an accelerometer device in communication with a social network, in accordance with some embodiments of the present invention. In an example embodiment, Sqord can include or interface with an online social network where individuals can indicate their relationship to other members and non-members. Moreover, Sqord can allow users to identify their offline social memberships like their organization, classroom etc. In another example embodiment, the social network can be geared towards identifying physical-activity based relationships. Users can be encouraged to identify other members with whom they participate in physical activity together as friends on the website. As a result, a social network for interfacing with Sqord can be designed to be a strong reflection of a user's offline peer-based physical activity social group.

A user's social network presence can provide strong features for activity recognition. Many times, physical activities occur as a part of group activity, for example, a school PE class. Also, many sports (like basketball) are team activities. Multiple members from a social group have to coordinate to participate in them. Therefore, variables like duration, timing, intensity and type of physical activity can exhibit strong co-relations between members of a same social group like a classroom.

To improve the accuracy of activity recognition algorithms, some embodiments of Sqord can use a combination of time series data generated by sensor and also features mined from a user's social network. In an example embodiment, Sqord can be associated with a website. On the Sqord website, users can be allowed to index and provide tags to indicate the type of physical activity. For example, a user can indicate that between 10:00-11:00 AM on 12-12-2012, he was playing basketball.

Manual tagging by users can provide some embodiments of Sqord with highly accurate labeled data. In one embodiment, the following example algorithm (Algorithm A) can use this labeled data to augment the accuracy of the activity prediction algorithm as follows:
1) To recognize the type of activity, an activity detection algorithm can be used to index non-sedentary activity period exhibited by a user. Let the start time be t⁰ and end time be t¹.
2) For each type of activity x, the number of votes, or the number of the user's peers on the social network (e.g., members of his offline social network like his organization or other users that were denoted as friends), who labeled their activity x during the interval between t¹ to t⁰; each vote is weighted by the length of intersection between the labeled activity and the current activity of interest. Also, an additional weight to indicate the type of relationship between the current user and the user of the labeled activity can be used. Furthermore, another weight can be used to indicate the similarities between the time series of the current user and time series of the user with the labeled data. The time series similarity can be calculated multiple ways. An average value of the reading during the time series is a scalar metric that can be used to compute distance between two time series. Histogram distances between two time series data can also be used. These weights can be set by trial and error method to maximize performance on a set of training data.
3) The activity between t⁰ and t¹ is labeled either unknown if no activity has sufficient votes (as determined by a pre-set threshold) or as the activity with the maximum number of votes.

Use-optimization problems can be solved to set the weights, for example, by using greedy algorithms like genetic algorithms. For this approach, a training set can be prepared (e.g., a collection of data where the correct final labels are known). Then, an evolutionary algorithm like the Genetic Algorithm can be used to evolve to the optimal weights that can give improved performance in predicting the final labels.

A more sophisticated algorithm can be used where the time-series based features can be combined with the social network based features described to provide hybrid activity recognition algorithm. A model similar to the one described in Section 4 for recognizing the body part associated with a sensor can be used for activity recognition. In addition to the time series features described in Section 4, social network features described in Algorithm A can be used to augment the feature vector.

We can use an iterative learning algorithm to converge to the activity labels, as follows.
1) First, the current activities are generated by the machine learning module for the social network, using only the manually labeled activity labels.
2) Using the labels generated by step 1, each user's activity label is re-generated using the updated social network features (using both data labeled by users and data labeled by step 1).
3) Steps 1 and 2 are repeated till convergence.

### 6. Rewarding Activity Levels

Some embodiments of the present invention can reward users for maintaining certain activity levels or reaching activity goals. Various incentive mechanisms can be used to reward or encourage healthy behavior. Moreover, rewards can be real-world or virtual items. For example, a user could gain an honorary title or certain privileges on a social network associated with the platform. Additional virtual rewards can include celebrity collectibles like personalized congratulatory or encouraging messages from role-models are celebrities that are showcased to a user's social network. In some embodiments, users can register as a group with awards periodically awarded to the top performers, most improved user, or other group centric metrics. Similarly, groups of users could compete against other groups for prizes or bragging rights. In some embodiments, a user may be rewarded for achieving objective fitness standards, such as the current U.S. and WHO guidelines for physical activity. In another example embodiment, a user may set their own goals and be rewarded for reaching those goals.

### 7. Character-based Accelerometer Devices for Encouraging Participation

To motivate kids to use the devices on a regular basis, according to some embodiments of the present invention, accelerometers and other hardware can be embedded in character likenesses and sold as collectable physical goods. For example, a range of sculpted, plastic character figures either created (and owned) by Sqord, or licensed from 3rd party owners, or licensed as likenesses of real celebrities (sports stars, etc.) can contain a hardware component that enables that figure to sync some data with Sqord through coupling of that figure (or some part of that figure, if multiple pieces) with a Sqord device. Figures can be available for sale as physical goods online or in retail outlets. Some figures can contain accelerometers for directly measuring activity for syncing to Sqord. In these cases, players can directly carry that figure (or some part of that figure, if the figure comprises multiple pieces) to measure physical activity.

In another example embodiment, some figures can contain surprise benefits, even among the same “type” of figure. For example, some limited number could award the purchasing player a very rare benefit, without any indication on the packaging or documentation.

Some figures can, by virtue of their purchase, extend the account term of that user's Sqord account. In some embodiments, this can become a primary account renewal method. In another example embodiment, figures can contain batteries that (in most cases) could not be changed by a player, creating a limited time of “playable” value. To reduce the chance of player cheating, limited times of usability could be hard-coded in some figures. In yet another example embodiment, figures can have limited quantities or availability, creating a secondary value of collectability that exists beyond the expected battery life.

Moreover, in another example embodiment, some figures (which may or may not also contain an accelerometer) can contain one-time benefits to the user upon syncing—for example:
Offering a short term bonus to user metrics, for example, on the Sqord website or partner platforms;
Unlocking access to otherwise unavailable virtual goods;
Unlocking access to an otherwise invisible or closed game; and
Opening communication channels to a celebrity, for example, via a Sqord communication channel.

### 8. Example Systems

Various embodiments of the present invention can be embodied in non-transitory computer readable media for execution by one or more processors. An example embodiment can be used in an application of a computing device, such as a smartphone or tablet, but other computing devices, including non-portable computing devices, can also be used.

FIG. 8 depicts a block diagram of illustrative computer system architecture according to an example embodiment. Certain aspects of FIG. 8 may be embodied in a computing device. As desired, embodiments of the disclosed technology may include a computing device with more or less of the components illustrated in FIG. 8. It will be understood that the computing device architecture 800 is provided for example purposes only and does not limit the scope of the various embodiments of the present disclosed systems, methods, and computer-readable mediums.

The computing device architecture 800 of FIG. 8 includes a CPU 802, where computer instructions are processed; a display interface 806 that acts as a communication interface and provides functions for rendering video, graphics, images, and texts on the display. According to certain some embodiments of the disclosed technology, the display interface 806 may be directly connected to a local display, such as a touch-screen display associated with a mobile computing device. In another example embodiment, the display interface 806 may be configured for providing data, images, and other information for an external/remote display that is not necessarily physically connected to the mobile computing device. For example, a desktop monitor may be utilized for mirroring graphics and other information that is presented on a mobile computing device. According to certain some embodiments, the display interface 806 may wirelessly communicate, for example, via a Wi-Fi channel or other available network connection interface 882 to the external/remote display.

In an example embodiment, the network connection interface 882 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

The computing device architecture 800 may include a keyboard interface 804 that provides a communication interface to a keyboard. In one example embodiment, the computing device architecture 800 may include a presence-sensitive display interface 807 for connecting to a presence-sensitive display. According to certain some embodiments of the disclosed technology, the presence-sensitive display interface 807 may provide a communication interface to various devices such as a pointing device, a touch screen, a depth camera, etc. which may or may not be associated with a display.

The computing device architecture 800 may be configured to use an input device via one or more of input/output interfaces (for example, the keyboard interface 804, the display interface 806, the presence sensitive display interface 807, network connection interface 882, camera interface 814, sound interface 816, etc.) to allow a user to capture information into the computing device architecture 800. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 800 or may be a separate device. For example, the input device may be an accelerometer, a magnetometer, a digital camera, a microphone, and an optical sensor.

Example embodiments of the computing device architecture 800 may include an antenna interface 880 that provides a communication interface to an antenna; a network connection interface 882 that provides a communication interface to a network. According to certain embodiments, a camera interface 814 is provided that acts as a communication interface and provides functions for capturing digital images from a camera. According to certain embodiments, a sound interface 816 is provided as a communication interface for converting sound into electrical signals using a microphone and for converting electrical signals into sound using a speaker. According to example embodiments, a random access memory (RAM) 818 is provided, where computer instructions and data may be stored in a volatile memory device for processing by the CPU 802.

According to an example embodiment, the computing device architecture 800 includes a read-only memory (ROM) 820 where invariant low-level system code or data for basic system functions such as basic input and output (I/O), startup, or reception of keystrokes from a keyboard are stored in a non-volatile memory device. According to an example embodiment, the computing device architecture 800 includes a storage medium 822 or other suitable type of memory (e.g., RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 824, application programs 826 (including, for example, a web browser application, a widget or gadget engine, and or other applications, as necessary) and data files 828 are stored. According to an example embodiment, the computing device architecture 800 includes a power source 130 that provides an appropriate alternating current (AC) or direct current (DC) to power components. According to an example embodiment, the computing device architecture 800 includes a telephony subsystem 132 that allows the device 800 to transmit and receive sound over a telephone network. The constituent devices and the CPU 802 communicate with each other over a bus 134.

According to an example embodiment, the CPU 802 has appropriate structure to be a computer processor. In one arrangement, the CPU 802 may include more than one processing unit. The RAM 818 interfaces with the computer bus 134 to provide quick RAM storage to the CPU 802 during the execution of software programs such as the operating system application programs, and device drivers. More specifically, the CPU 802 loads computer-executable process steps from the storage medium 822 or other media into a field of the RAM 818 in order to execute software programs. Data may be stored in the RAM 818, where the data may be accessed by the computer CPU 802 during execution. In one example configuration, the device architecture 800 includes at least 825 MB of RAM, and 256 MB of flash memory.

The storage medium 822 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 822, which may comprise a machine-readable storage medium.

According to one example embodiment, the term computing device, as used herein, may be a CPU, or conceptualized as a CPU (for example, the CPU 802 of FIG. 8). In this example embodiment, the computing device may be coupled, connected, and/or in communication with one or more peripheral devices, such as display. In another example embodiment, the term computing device, as used herein, may refer to a mobile computing device 200, such as a smartphone or tablet computer. In this example embodiment, the computing device may output content to its local display and/or speaker(s). In another example embodiment, the computing device may output content to an external display device (e.g., over Wi-Fi) such as a TV or an external computing system.

In some embodiments of the disclosed technology, the computing device 200 may include any number of hardware and/or software applications that are executed to facilitate any of the operations. In some embodiments, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various embodiments of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems. As desired, embodiments of the present invention can include the device computing system architecture with more or less of the components illustrated in FIG. 8.

Certain embodiments of the present invention are described above with reference to block and flow diagrams of systems and methods and/or computer program products according to example embodiments of the present invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams can not necessarily need to be performed in the order presented, or can not necessarily need to be performed at all, according to some embodiments of the present invention.

These computer-executable program instructions can be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions can also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present invention can provide for a computer program product, comprising a computer-usable medium having a computer-readable program code or program instructions embodied therein, said computer-readable program code adapted to be executed to implement one or more functions specified in the flow diagram block or blocks. The computer program instructions can also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present invention have been described in connection with what is presently considered to be the most practical and various embodiments, it is to be understood that the present invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

While systems and methods for measuring and rewarding activity levels have been disclosed in example forms, it will be apparent to those skilled in the art that many modifications, additions, and deletions can be made without departing from the spirit and scope of the system, method, and their equivalents, as set forth in claims to be filed in a later non-provisional patent application.

What is claimed is:

1. A system comprising:
a processor;
an orientation sensor operatively coupled to the processor;
a memory operatively coupled to the processor and configured for storing data and instructions that, when executed by the at least one processor, cause the system to:
receive sensor data from the orientation sensor, the sensor data sampled at N hertz, wherein N is a predetermined frequency;
determining, by the processor, and based on the sensor data, a number of steps by a human user per a unit of time;
storing, on the memory, and based on the number of steps, a binary activity level in a sliding t minute window, wherein t is a predetermined amount of time;
generating, by the processor, a binary string T comprising N consecutive time-slots, each time-slot from the N consecutive time-slots, indicating t minutes of activity, comprising:
responsive to determining, in a first instance, that the number of steps in the sliding t minute window exceeds a predetermined threshold, assigning a “1” to a time slot corresponding to the first instance; and
responsive to determining, in a first instance, that the number of steps in the sliding t minute window does not exceed the predetermined threshold, assigning a “0” to a time slot corresponding to the second instance; and
outputting, to a computing device external to the system, the binary string.
